(19) United States
(12) Patent Application Publication
(10) Pub. No.: US 2013/0146682 A1
(43) Pub. Date: Jun. 13, 2013

(54) TARGET SUPPLY DEVICE

(71) Applicant: GIGAPHOTON INC., Oyama-shi (JP)

(72) Inventors: Takanobu ISHIHARA, Hiratsuka-shi (JP); Osamu WAKABAYASHI, Hiratsuka-shi (JP); Toshiyuki HIRASHITA, Hiratsuka-shi (JP)

(73) Assignee: GIGAPHOTON INC., Oyama-shi (JP)

(21) Appl. No.: 13/655,320

(22) Filed: Oct. 18, 2012

(30) Foreign Application Priority Data
Dec. 9, 2011 (JP) 2011-270264
Aug. 24, 2012 (JP) 2012-185083

(51) Int. Cl. B05B 1/14

(52) U.S. Cl. 239/590

(57) ABSTRACT

A target supply device may include a reservoir configured to store a target material, the reservoir having a first channel through which the target material passes, a nozzle plate having a second channel through which the target material passes after passing through the first channel, and a filter having a first surface and a second surface and provided between the reservoir and the nozzle plate such that the first surface and the reservoir are face-sealed and the second surface and the nozzle plate are face-sealed, the filter having a plurality of through-holes through which the target material passes.

### CROSS-REFERENCE TO RELATED APPLICATION

The present application claims priority from Japanese Patent Application No. 2011-270264 filed Dec. 9, 2011, and Japanese Patent Application No. 2012-185083 filed Aug. 24, 2012.

### BACKGROUND

1. Technical Field

The present disclosure relates to target supply devices.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A target supply device according to an aspect of the present disclosure may include a reservoir configured to store a target material, the reservoir having a first channel through which the target material passes, a nozzle plate having a second channel through which the target material passes after passing through the first channel, and a filter having a first surface and a second surface and provided between the reservoir and the nozzle plate such that the first surface and the reservoir are face-sealed and the second surface and the nozzle plate are face-sealed, the filter having a plurality of through-holes through which the target material passes.

### BRIEF DESCRIPTION OF THE DRAWINGS

Hereinafter, selected embodiments of the present disclosure will be described with reference to the accompanying drawings.

FIG. 1 schematically illustrates a configuration of an exemplary LPP-type EUV light generation system.

FIG. 2 is a partial sectional view illustrating an exemplary configuration of an EUV light generation apparatus according to a first embodiment of the present disclosure.

FIG. 3 is a partial sectional view illustrating the target supply device shown in FIG. 2 and peripheral components thereof.

FIG. 4A is a sectional view of the filter shown in FIG. 3 and peripheral components thereof.

FIG. 4B is a bottom view of the nozzle plate as viewed in the direction of an arrow IVB.

FIG. 4C is a sectional view of the filter shown in FIG. 4A.

FIG. 5 is a sectional view illustrating an exemplary filter of a target supply device and peripheral components of the filter in an EUV light generation apparatus according to a second embodiment of the present disclosure.

FIG. 6 is a fragmentary sectional view of an exemplary target supply device and peripheral components thereof in an EUV light generation apparatus according to a third embodiment of the present disclosure.

FIG. 7 is a sectional view illustrating an exemplary nozzle of a target supply device and peripheral components of the nozzle in an EUV light generation apparatus according to a fourth embodiment of the present disclosure.

FIG. 8 is a sectional view illustrating an exemplary nozzle of a target supply device and peripheral components of the nozzle in an EUV light generation apparatus according to a fifth embodiment of the present disclosure.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

### 1. Overview

### 2. Overview of EUV Light Generation System

### 2.1 Configuration

### 2.2 Operation

### 3. EUV Light Generation Apparatus Including Target Supply Device Having Filter

### 3.1 Configuration

### 3.2 Operation

### 4. Target Supply Device Including Filter

### 4.1 Configuration

### 4.2 Operation

### 4.3 Details of Filter

5. Target Supply Device with Different Filter Arrangement

### 6. Target Supply Device Including Nozzle of Different Shape

### 7. Target Supply Device Including Nozzle of Different Shape

### 8. Target Supply Device Including Nozzle of Different Shape

### 1. Overview

In an LPP type EUV light generation apparatus, a target material may be outputted through a nozzle of a target supply device in the form of droplets into a chamber. The target supply device may be controlled so that a droplet of the target material reaches a plasma generation region in the chamber at a desired timing. The droplet may be irradiated with a pulse laser beam when the droplet reaches the plasma generation region. Then, the target material forming the droplet may be turned into plasma, and EUV light may be emitted from the plasma.

However, if solid particles enter an opening in the nozzle of the target supply device, the opening may be clogged, or the diameter of the opening may change. In such a case, a droplet may not be outputted from the target supply device, or the moving path or the moving speed of an outputted droplet may vary. When the moving path or the moving speed of a droplet varies, the droplet may not reach the plasma generation region at a desired timing.

According to one aspect of the present disclosure, a filter may be provided between a reservoir and a nozzle plate, and a target material may pass through the filter prior to reaching the opening in the nozzle plate. Thus, particles may be prevented from entering the opening in the nozzle plate. As a result, clogging in the opening and/or a change in the diameter of the opening may be suppressed.

### 2. Overview of EUV Light Generation System

### 2.1 Configuration

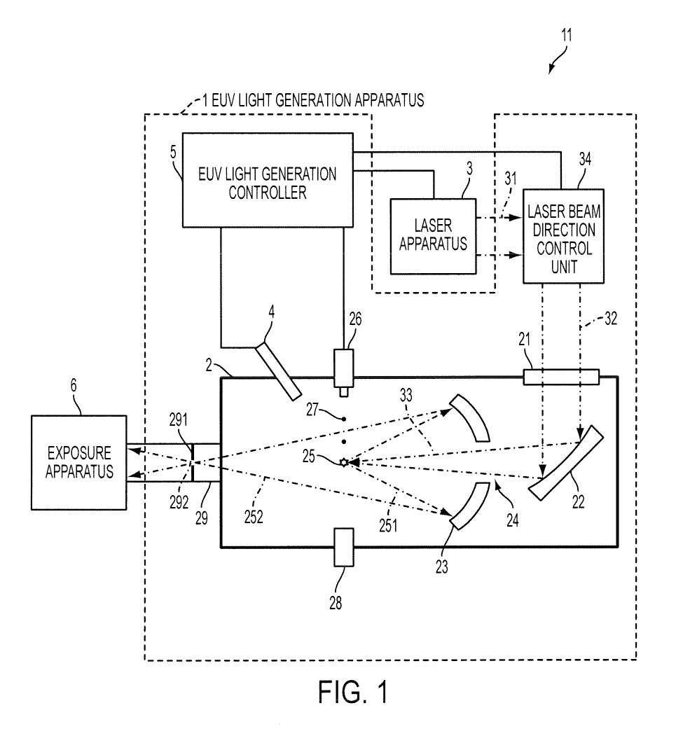

FIG. 1 schematically illustrates a configuration of an exemplary LPP type EUV light generation system. An EUV light generation apparatus 1 may be used with at least one laser apparatus 3. Hereinafter, a system that includes the EUV light generation apparatus 1 and the laser apparatus 3 will be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, the trajectory, the position, and the speed of a target 27.

Further, the EUV light generation system 11 may include a connection part 29 for allowing the interior of the chamber 2 to be in communication with the interior of the exposure apparatus 6. A wall 291 having an aperture may be provided in the connection part 29, and the wall 291 may be positioned such that the second focus of the EUV collector mirror 23 lies in the aperture formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

2.2 Operation

With continued reference to FIG. 1, a pulse laser beam 31 outputted from the laser apparatus 3 may pass through the laser beam direction control unit 34 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of the timing at which the target 27 is outputted and the direction into which the target 27 is outputted. Furthermore, the EUV light generation controller 5 may be configured to control at least one of the timing at which the laser apparatus 3 oscillates, the direction in which the pulse laser beam 31 travels, and the position at which the pulse laser beam 33 is focused. It will be appreciated that the various controls mentioned above are merely examples, and other controls may be added as necessary.

### 3. EUV Light Generation Apparatus Including Target Supply Device Having Filter

### 3.1 Configuration

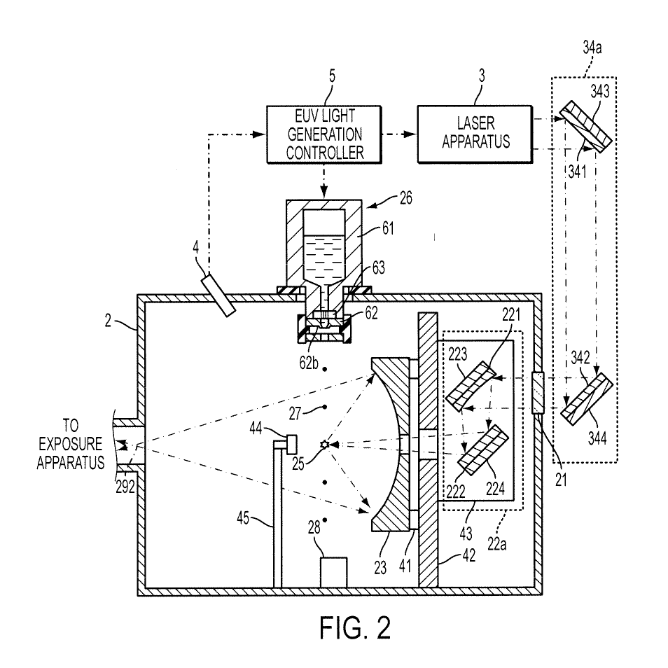

FIG. 2 is a partial sectional view illustrating an exemplary configuration of an EUV light generation apparatus according to a first embodiment of the present disclosure. As shown in FIG. 2, a laser beam focusing optical system 22a, the EUV collector mirror 23, the target collector 28, an EUV collector mirror mount 41, plates 42 and 43, a beam dump 44, and a beam dump support member 45 may be provided inside the chamber 2.

The plate 42 may be attached to the chamber 2, and the plate 43 may be attached to the plate 42. The EUV collector mirror 23 may be attached to the plate 42 through the EUV collector mirror mount 41.

The laser beam focusing optical system 22a may include an off-axis paraboloidal mirror 221, a flat mirror 222, and holders 223 and 224 for the respective mirrors 221 and 222. Each of the off-axis paraboloidal mirror 221 and the flat mirror 222 may be fixed to the plate 43 through the respective mirror holders 223 and 224 such that a laser beam reflected sequentially by the mirrors 221 and 222 is focused in the plasma generation region 25. The beam dump 44 may be fixed to the chamber 2 through the beam dump support member 45 so that the beam dump 44 is positioned in an extension of a beam path of a laser beam reflected by the flat mirror 222. The target collector 28 may be provided in an extension of the designed trajectory of targets 27.

The chamber 2 may include the window 21 and the target supply device 26. The target supply device 26 may include a reservoir 61, a nozzle plate 62, and a filter 63. Mating surfaces between the reservoir 61 and the filter 63 and between the nozzle plate 62 and the filter 63 may be airtightly sealed.

The reservoir 61 may be configured to store a target material in a molten state. The reservoir 61 may be formed of a material that is less reactive with the target material. For example, when tin is used as a target material, the reservoir 61 may be formed of at least one of molybdenum (Mo), tungsten (W), quartz (SiO₂), and silicon carbide (SiC).

The nozzle plate 62 may have a through-hole formed therein to allow the target material to pass therethrough. The nozzle plate 62 may have a protrusion 62b, and the aforementioned through-hole may open at the protrusion 62b.

The filter 63 may be provided between the reservoir 61 and the nozzle plate 62. The reservoir 61, the nozzle plate 62, and the filter 63 may be formed of the same material, such as molybdenum (Mo), tungsten (W), quartz (SiO₂), and silicon carbide (SiC). When these components are formed of the same material, the coefficient of thermal expansion of these components are substantially the same. Thus, even when the target material is heated to a temperature equal to or higher than its melting point, sliding along the sealing surfaces between the reservoir 61 and the filter 63 and between the filter 63 and the nozzle plate 62 may be suppressed. As a result, generation of particles or leakage of the target material through the sealing surfaces may be suppressed.

A laser beam direction control unit 34a and the EUV light generation controller 5 may be provided outside the chamber 2. The laser beam direction control unit 34a may include high-reflection mirrors 341 and 342 and holders 343 and 344 for holding the respective high-reflection mirrors 341 and 342.

### 3.2 Operation

The liquid target material stored in the reservoir 61 of the target supply device 26 may pass through the filter 63. Then, particles present in the reservoir 61 or generated in the reservoir 61 may be trapped by the filter 63. The target material that has passed through the filter 63 may be outputted into the chamber 2 in the form of droplets as targets 27 through the through-hole formed in the nozzle plate 62. The target 27 outputted as such may be supplied to the plasma generation region 25 in the chamber 2.

A pulse laser beam outputted from the laser apparatus 3 may be reflected by the high-reflection mirrors 341 and 342, and may enter the laser beam focusing optical system 22a through the window 21. The pulse laser beam that has entered the laser beam focusing optical system 22a may be reflected sequentially by the off-axis paraboloidal mirror 221 and the flat mirror 222. The EUV light generation controller 5 may carry out a control so that the target 27 outputted from the target supply device 26 is irradiated with the pulse laser beam at a timing when the target 27 reaches the plasma generation region 25.

### 4. Target Supply Device Including Filter

### 4.1 Configuration

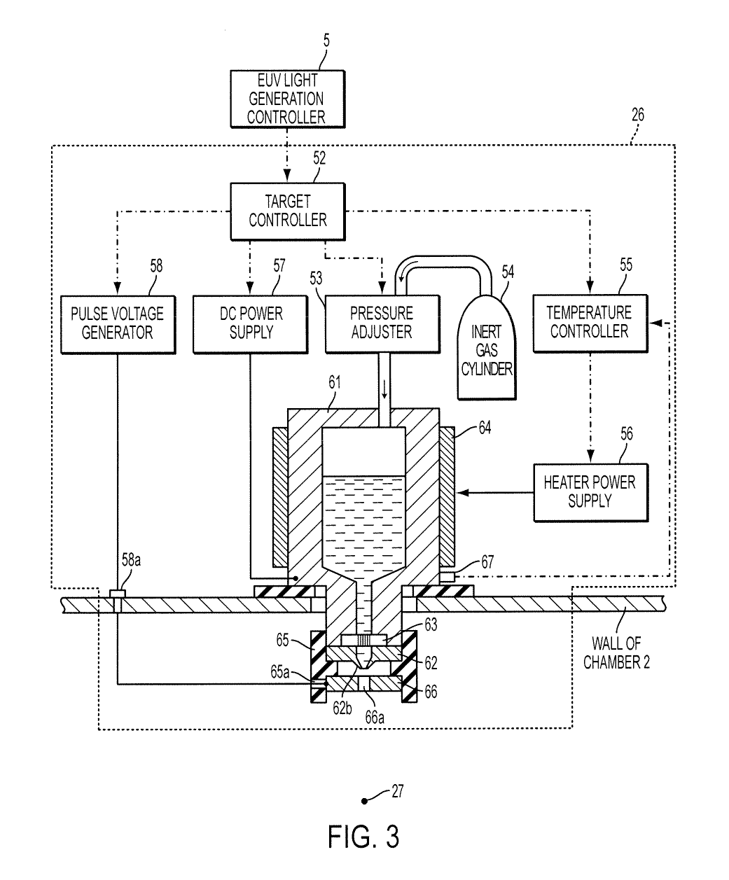

FIG. 3 is a partial sectional view illustrating the target supply device shown in FIG. 2 and peripheral components thereof. As shown in FIG. 3, the target supply device 26 may further include a heater 64, an electrically insulating member 65, a pull-out electrode 66, a temperature sensor 67, a target controller 52, a pressure adjuster 53, an inert gas cylinder 54, a temperature controller 55, a heater power supply 56, a DC power supply 57, and a pulse voltage generator 58.

The heater 64 may be attached on the outer surface of the reservoir 61 to heat the reservoir 61 so that the target material in the reservoir 61 is kept in a molten state. The reservoir 61 may be mounted on the wall of the chamber 2 with an insulator provided therebetween.

The electrically insulating member 65 may be cylindrical in shape. The electrically insulating member 65 may hold the nozzle plate 62 and may be fixed to the reservoir 61. The pull-out electrode 66 may also be held by the electrically insulating member 65 such that the pull-out electrode 66 faces the nozzle plate 62 with a predetermined space secured therebetween. The electrically insulating member 65 may provide electrical insulation between the nozzle plate 62 and the pull-out electrode 66. The pull-out electrode 66 may have a through-hole 66a formed therein to allow targets 27 to pass therethrough.

The inert gas cylinder 54 may be connected to the pressure adjuster 53 through a pipe. The pressure adjuster 53 may be in communication with the interior of the reservoir 61 through another pipe. An output terminal of the DC power supply 57 may be electrically connected to the reservoir 61. An output terminal of the pulse voltage generator 58 may be electrically connected to the pull-out electrode 66 through a feedthrough 58a provided in the chamber 2 and a through-hole 65a formed in the electrically insulating member 65.

### 4.2 Operation

The temperature sensor 67 may be configured to measure the temperature of the reservoir 61 and output an output signal indicative of a measurement result. An output signal from the temperature sensor 67 may be inputted to the temperature controller 55. A control signal from the target controller 52 may also be inputted to the temperature controller 55. The temperature controller 55 may output a drive signal to the heater power supply 56 in accordance with an output signal from the temperature sensor 67 and a control signal from the target controller 52. The heater power supply 56 may supply electric power to the heater 64 in accordance with a drive signal from the temperature controller 55. The reservoir 61 may then be heated by the heater 64 to a temperature, for example, equal to or higher than 232° C., which is the melting point of tin. Thus, the target material stored in the reservoir 61 may be kept in a molten state.

The target controller 52 may be configured to output target generation signals respectively to the DC power supply 57 and the pulse voltage generator 58. The DC power supply 57 may apply a constant potential to the target material in the reservoir 61. The pulse voltage generator 58 may apply a pulse voltage to the pull-out electrode 66 in accordance with a received target generation signal. Thus, the Coulomb force may be generated between the target material and the pull-out electrode 66, and the target material may be pulled out through the through-hole formed in the nozzle plate 62. As a result, a charged target 27 may be generated.

The pressure adjuster 53 may be configured to adjust the pressure of the inert gas supplied from the inert gas cylinder 54 and pressurize the target material in the reservoir 61 by the inert gas in accordance with a control signal from the target controller 52. As the target material is pressurized by the inert gas, the target material may protrude slightly from the protrusion 62b through the through-hole. Then, an electric field may be enhanced at the protruding target material, and the Coulomb force may be enhanced between the protruding target material and the pull-out electrode 66. The target controller 52 may be configured to control the pressure adjuster 53 and the pulse voltage generator 58 so that a target 27 is generated at a timing specified by the EUV light generation controller 5.

### 4.3 Details of Filter

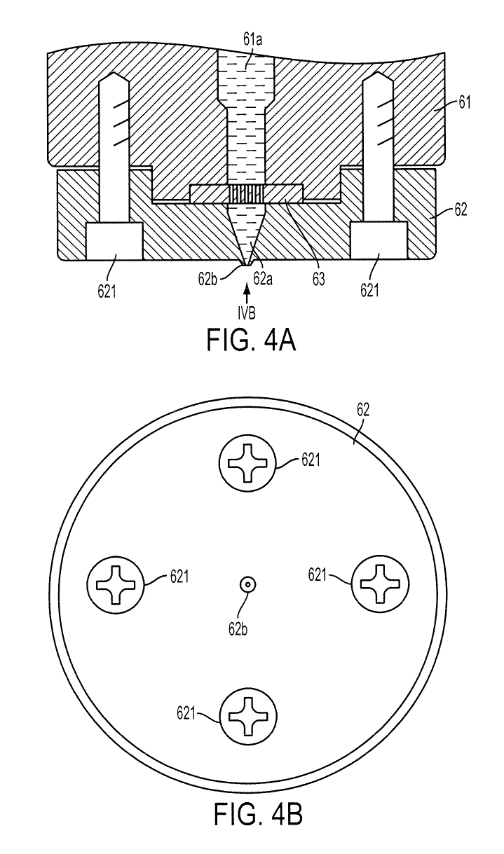

FIG. 4A is a sectional view of the filter shown in FIG. 3 and peripheral components thereof. FIG. 4B is a bottom view of the nozzle plate as viewed in the direction of an arrow IVB. FIG. 4C is a sectional view of the filter shown in FIG. 4A. As shown in FIG. 4A, a channel 61a may be formed in the reservoir 61 to allow a liquid target material to pass therethrough. The nozzle plate 62 may have a channel 62a to allow the liquid target material to pass therethrough. The reservoir 61 and the nozzle plate 62 may be coupled to each other through a fitting structure formed around the channel 61a and the channel 62a, respectively. The fitting structure may prevent the reservoir 61 and the nozzle plate 62 from being displaced relative to each other. Accordingly, sliding along sealing surfaces between the reservoir 61 and the filter 63 and between the nozzle plate 62 and the filter 63 may be suppressed, and particles may be prevented from being generated. The target material may flow from the channel 61a into the channel 62a. The channel 62a may be tapered in shape whose diameter reduces from the upstream side to the downstream side of the channel 62a.

The filter 63, which may be disc-shaped, may be provided between the reservoir 61 and the nozzle plate 62 to be interposed between the channel 61a and the channel 62a. The filter 63 may have a first surface 631 and a second surface 632 (see FIG. 4C), and may be provided such that the first surface 631 is fitted in a recess formed in the reservoir 61 and the second surface 632 makes contact with the nozzle plate 62.

As shown in FIG. 4C, the filter 63 may have a plurality of through-holes 63a penetrating in the axial direction of the filter. Each of the through-holes 63a may include a first portion 63b and a second portion 63c, and the first portion 63b may be larger in diameter than the second portion 63c. Each of the through-holes 63a may be formed such that the first portion 63b is located to the side of the first surface 631 and the second portion 63c is located to the side of the second surface 632. When forming the through-hole 63a, the first portion 63b may first be formed through drilling or other mechanical machining means and the second portion 63c may then be formed through electrical-discharge machining. The second portion 63c may preferably have a diameter smaller than the smallest diameter of the channel 62a. Alternatively, each of the through-holes 63a in the filter 63 may be tapered in shape whose diameter decreases from the side of the first surface 631 to the side of the second surface 632. In this case, the smallest diameter of the through-hole 63 may preferably be smaller than the smallest diameter of the channel 62a formed in the nozzle plate 62.

The first surface 631 of the filter 63 and the reservoir 61 may be face-sealed. The second surface 632 of the filter 63 and the nozzle plate 62 may be face-sealed. These face seals may be realized by subjecting each of the sealing surfaces between the filter 63 and the reservoir 61 and between the filter 63 and the nozzle plate 62 to mirror-like finishing.

Each of the nozzle plate 62 and the reservoir 61 may have threaded holes into which bolts 621 may be inserted. The nozzle plate 62 may be fixed to the reservoir 61 with the plurality of bolts 621 with the filter 63 sandwiched between the nozzle plate 62 and the reservoir 61. In the example shown in FIG. 4B, four bolts 621 are used. The bolts 621 may preferably be formed of the same material as the reservoir 61, the nozzle plate 62, and the filter 63. Further, as shown in FIG. 4B, the plurality of bolts 621 may preferably be fixed symmetrically about the axis of the nozzle plate 62.

According to the first embodiment, since the filter 63 is provided between the reservoir 61 and the nozzle plate 62, and the target material passes through the filter 63 prior to reaching the channel 62a in the nozzle plate 62, particles may be prevented from entering the channel 62a. As a result, clogging in the channel 62a or a change in the diameter of the channel 62a may be suppressed.

Further, since particles may be prevented from entering the channel 62a, the output direction of the targets 27 may be stabilized. Furthermore, since the plurality of through-holes 63a is formed in the filter 63, even if particles are clogged in some of the through-holes 63a, the target material may still pass through the remaining through-holes 63a.

5. Target Supply Device with Different Filter Arrangement

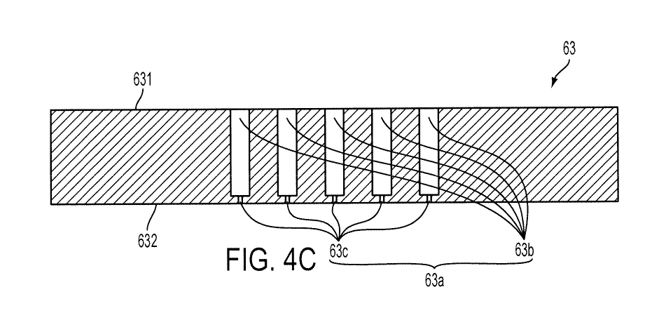

FIG. 5 is a sectional view illustrating an exemplary filter of a target supply device and peripheral components of the filter in an EUV light generation apparatus according to a second embodiment of the present disclosure. In the second embodiment, as shown in FIG. 5, each of the through-holes 63a in the filter 63 may be formed such that the first portion 63b is located at the side of the second surface 632 and the second portion 63c, which is smaller in diameter than the first portion 63b, is located at the side of the first surface 631. The filter 63 configured as such may be provided such that the first surface 631 is in contact with the reservoir 61 and the second surface 632 is in contact with the nozzle plate 62.

In the first embodiment, since the first portion 63b is located upstream from the second portion 63c, some particles may flow into the first portion 63b and remain in the first portion 63b. Thus, the through-hole(s) 63 may be clogged.

On the other hand, in the second embodiment, since the second portion 63c is located upstream from the first portion 63b, particles that, if any, have entered the second portion 63c may be prevented from remaining therein. That is, particles may be deposited on the first surface 631 of the filter 63 in a substantially uniform distribution. Accordingly, the second portion 63c may be prevented from being clogged, and the decrease in the flow rate of the target material may be suppressed.

### 6. Target Supply Device Including Nozzle of Different Shape

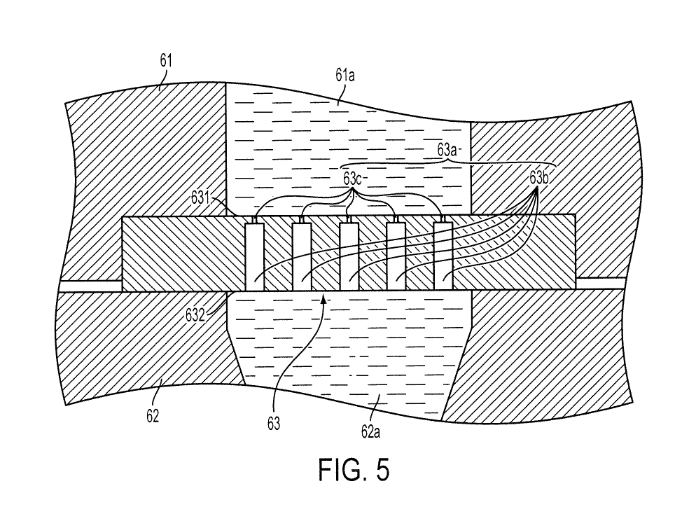

FIG. 6 is a fragmentary sectional view illustrating a nozzle of an exemplary target supply device according to a third embodiment of the present disclosure and peripheral components thereof. A target supply device 26a according to the third embodiment may include a reservoir 71 having a channel 71a, a member 72 having a channel 72a, a filter 73, a nozzle pipe 74, and a coupling member 75.

An external thread 71b may be formed in the reservoir 71 at a portion at which the reservoir 71 comes into contact with the coupling member 75. The nozzle pipe 74 may be fitted into the member 72. The member 72 may include a first portion 72b and a second portion 72c. The first portion 72b may have a larger outer diameter than the second portion 72c. The member 72 configured as such may be provided such that the first portion 72b is located upstream from the second portion 72c. The configuration of the filter 73 may be similar to that of the filter 63 of the first embodiment. The filter 73 may be provided between the reservoir 71 and the member 72.

The coupling member 75 may have a shape capable of housing the first portion 72b of the member 72 and the filter 73 thereinside. Further, an internal thread 75b may be formed at one end of the coupling member 75, and the external thread 71b in the reservoir 71 may be screwed into the internal thread 75b. An opening 75c may be formed at the other end of the coupling member 75. The opening 75c may be large enough to allow the second portion 72c of the member 72 to pass therethrough but not to allow the first portion 72b to pass therethrough. The outer surface (not specifically shown) of the coupling member 75 may, for example, be hexagonal in shape.

The first portion 72b of the member 72 and the filter 73 may be housed in the coupling member 75, and the second portion 72c of the member 72 may project from the coupling member 75 through the opening 75c. In this state, the external thread 71b and the internal thread 75b may be coupled to each other. With this configuration, the filter 73 may be provided between the channel 71a and the channel 72a. The filter 73 may have a plurality of through-holes 73a penetrating in the axial direction thereof.

A first surface 731 of the filter 73 and the reservoir 71 may be face-sealed, and a second surface 732 of the filter 73 and the member 72 may be face-sealed. These face seals may be realized by subjecting each the sealing surfaces between the filter 73 and the reservoir 71 and between the filter 73 and the member 72 to mirror-like finishing. Further, a surface of the reservoir 71 at which the reservoir 71 is in contact with the filter 73 and a surface of the member 72 at which the member 72 is in contact with the filter 73 may be curved as shown in FIG. 6. As compared to a case where these surfaces are flat, contact areas between the filter 73 and the reservoir 71 and between the filter 73 and the member 72 may be reduced. This, in turn, may reduce resistance that occurs when the reservoir 71 and the filter 73 are fixed to each other and the filter 73 and the member 72 are fixed each other by screwing the external thread 71b into the internal thread 75b.

The nozzle pipe 74 may be formed of quartz, such as glass, or molybdenum. When the member 72 is formed of molybdenum and the nozzle pipe 74 is formed of quartz, the member 72 and the nozzle pipe 74 may be connected to each other with a material that may absorb stress generated due to a difference in the coefficient of thermal expansion between these materials provided therebetween.

A piezoelectric ceramic element, such as a lead zirconate titanate (PZT) element 76, may be fixed to the nozzle pipe 74. A PZT driving power supply 77 may be electrically connected to the PZT element 76. The PZT driving power supply 77 may be connected to the target controller 52 through a signal line. Further, the target material in the reservoir 71 may be pressurized by an inert gas supplied from an inert gas cylinder (not separately shown) through a pressure adjuster (not separately shown). The inert gas cylinder and the pressure adjuster may be similar to those described in the first embodiment with reference to FIG. 3.

The target controller 52 may send a control signal to the PZT driving power supply 77 in accordance with a signal from the EUV light generation controller 5. The PZT driving power supply 77 may then apply a driving voltage to the PZT element 76 in accordance with the received control signal.

The target supply device 26a may be configured to output a target material on-demand in the form of droplets through the nozzle pipe 74. The PZT element 76 to which a driving voltage is applied causes the nozzle pipe 74 to deform at a predetermined timing to output the target material. Alternatively, a continuous jet of the target material can first be generated by the pressure adjuster, and the jet of the target material is then divided into droplets by the vibration of the PZT element 76 in accordance with a driving voltage.

In the third embodiment, since the filter 73 is provided between the member 72 and the reservoir 71, and the target material passes through the filter 73 prior to entering the channel 72a and the nozzle pipe 74, particles may be prevented from entering the channel 72a and the nozzle pipe 74 of the target supply device 26a. As a result, clogging in the channel 72a and the nozzle pipe 74 or a change in the diameter of the channel 72a and the nozzle pipe 74 may be suppressed.

### 7. Target Supply Device Including Nozzle of Different Shape

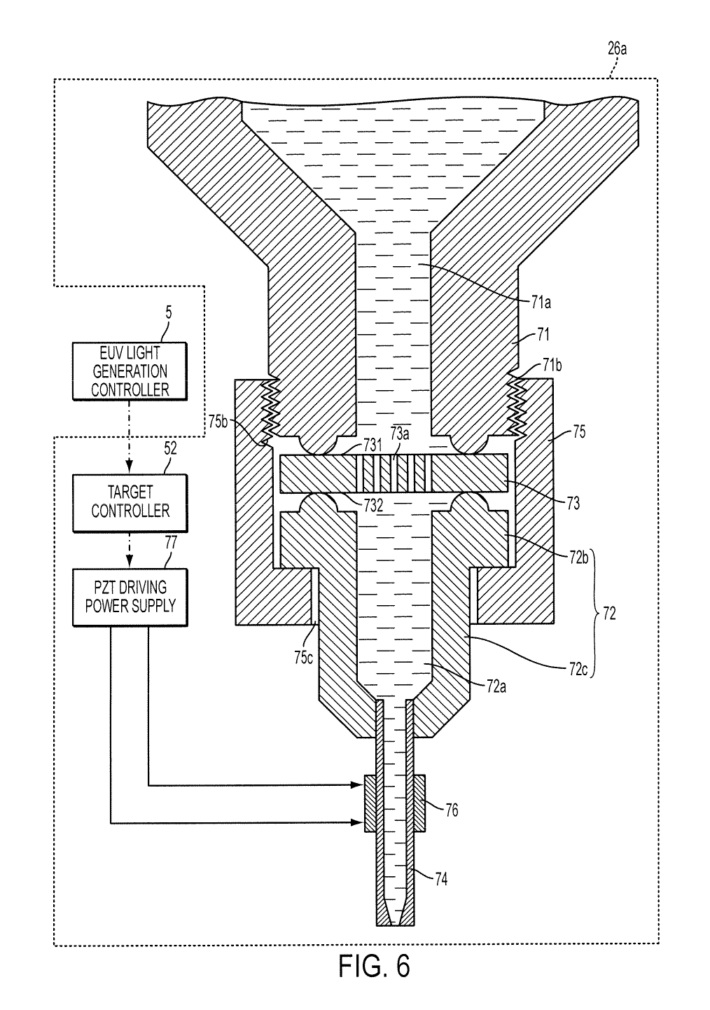

FIG. 7 is a sectional view illustrating an exemplary nozzle of a target supply device and peripheral components of the nozzle in an EUV light generation apparatus according to a fourth embodiment of the present disclosure. Although the protrusion 62b is formed on the nozzle plate 62 in the first embodiment, such a protrusion may not need to be provided when a pull-out electrode is not used.

As shown in FIG. 7, a nozzle plate 82 may have a through-hole 820 formed therein. The through-hole 820 may include a channel 82a, a nozzle opening 821, and a tapered portion 822. The channel 82a may be columnar in shape with a substantially constant diameter, and the target material that has passed through the filter 63 may first enter the channels 82a. The nozzle opening 821 may be a portion of the through-hole 820 at which the diameter is smallest and may be located downstream from the channel 82a. The tapered portion 822 may be located downstream from the nozzle opening 821 such that the diameter of the tapered portion increases from the upstream side to the downstream side. The liquid target material may be outputted into the tapered portion 822 through the nozzle opening 821 in the form of droplets, and may pass through the tapered portion 822 as targets 27.

As described in the third embodiment, as a method for outputting a target 27 without using a pull-out electrode, there is a method in which a target 27 is outputted by deforming the nozzle pipe 74 using the PZT element 76 (see FIG. 6). An alternative method may be such that a continuous jet of a target material is first generated using a pressure adjuster and the jet of the target material is then divided cyclically into droplets by the vibration of the PZT element 76.

In the first embodiment, the channel 62a may have a tapered shape whose diameter decreases from the upstream side toward the downstream side of the channel 62a. Thus, when particles are generated in the channel 62a located downstream from the filter 63, the particles may remain at the nozzle opening.

On the other hand, according to the fourth embodiment, the channel 82a is columnar in shape having a substantially constant diameter, and the tapered portion 822 is substantially conical in shape whose diameter increases toward the downstream side. Thus, even when particles are generated in the channel 82a, the particles may be prevented from remaining at the nozzle opening 821. Accordingly, clogging in the nozzle opening 821 or a change in the diameter of the nozzle opening 821 may be prevented, and an output direction of the targets 27 may be stabilized.

### 8. Target Supply Device Including Nozzle of Different Shape

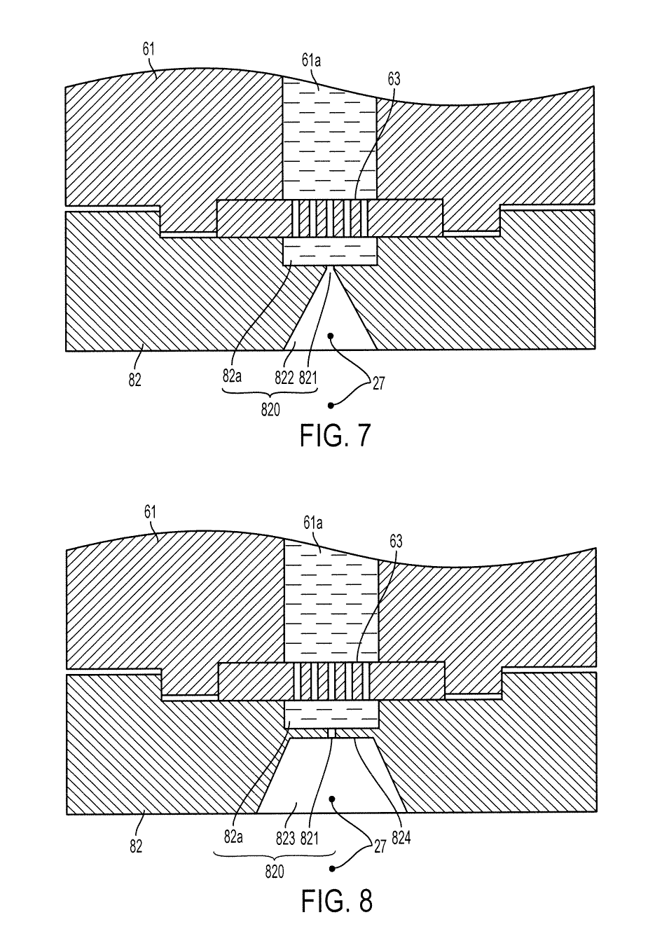

FIG. 8 is a sectional view illustrating an exemplary nozzle of a target supply device and peripheral components of the nozzle in an EUV light generation apparatus according to a fifth embodiment of the present disclosure. In the fourth embodiment, the tapered portion 822 is substantially conical in shape. In the fifth embodiment, however, a tapered portion 823 may be truncated-conical in shape. That is, in the fifth embodiment, a flat portion 824 may be present between the channel 82a and the tapered portion 823, and the nozzle opening 821 may be formed in the flat portion 824.

According to the fifth embodiment, even when the output direction of a target 27 outputted through the nozzle opening 821 varies, the target 27 may be prevented from coming into contact with the inner wall of the tapered portion 823. Accordingly, the target material may be prevented from adhering to and being deposited on the inner wall of the tapered portion 823, which, if occurs, may disadvantageously influence the output direction of the target 27.

The above-described embodiments and the modifications thereof are merely examples for implementing the present disclosure, and this disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A target supply device, comprising:
a reservoir configured to store a target material, the reservoir having a first channel through which the target material passes;
a nozzle plate having a second channel through which the target material passes after passing through the first channel; and
a filter having a first surface and a second surface and provided between the reservoir and the nozzle plate such that the first surface and the reservoir are face-sealed and the second surface and the nozzle plate are face-sealed, the filter having a plurality of through-holes through which the target material passes.

2. The target supply device according to claim 1, wherein the reservoir, the nozzle plate, and the filter are formed of materials that have substantially the same coefficient of thermal expansion.

3. The target supply device according to claim 1, wherein each of the reservoir, the nozzle plate, and the filter is formed of a material that is less reactive with the target material.

4. The target supply device according to claim 1, wherein the reservoir, the nozzle plate, and the filter are formed of the same material.

5. The target supply device according to claim 1, wherein each of the reservoir, the nozzle plate, and the filter is formed of one of molybdenum and tungsten.
